(19) United States
(12) Patent Application Publication
(10) Pub. No.: US 2010/0050409 A1
(43) Pub. Date: Mar. 4, 2010

(54) Method for making golf club head

(76) Inventors: Ming-Ching Liang, Anding Township Tainan County (TW); Tien-Ken Liang, Anding Township Tainan County (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/326,147

(22) Filed: Dec. 2, 2008

(30) Foreign Application Priority Data
Aug. 27, 2008 (TW) 097132640

(51) Int. Cl. B23P 17/00

(52) U.S. Cl. 29/412; 29/419.1

(57) ABSTRACT

A method for making a golf club head includes steps for processing upper and lower shells of the head. A metal- or non-metal-based composite material is provided which has a necessary thickness and whose area and total width are enough for making at least two unit shells, as determined by widths and surface curvatures of the upper and lower shells. A strip of excess material is reserved at a border between the unit shells. The two alternately or non-alternately arranged unit shells are integrally formed through a forming process, wherein an extension force generated while the unit shells are formed is constrained by the excess material to reduce deformation of the unit shells, so that the formed unit shells have flat cutting surfaces when the excess material is cut off, allowing the upper and lower shells thus made to have precise dimensions, improved ends of parts and close contact surfaces.

### BACKGROUND OF THE INVENTION

1. Technical Field

The present invention relates to a method for making a golf club head, and more particularly, to steps for processing upper and lower shells of a golf club head, wherein two unit shells to be pre-processed at the same time are arranged alternately or non-alternately, with a strip of excess material interposed therebetween for constraining an extension force generated while the two unit shells are formed, so that after the excess material is cut off from the two formed unit shells, the upper and lower shells thus obtained have close contact surfaces.

2. Description of Related Art

In order to increase the speed of a golf ball hit by a wood golf club head typically used for long-distance shots and improve the driving distance of such club heads, it is common practice in the golf club industry to use a die casting method to form upper and lower shells of a desired golf club head out of a metal-based composite material, and then use a numerically controlled (NC) milling machine to mill uneven contact surfaces of the die-cast shells. As the method described above is disadvantaged by long processing time and high costs, an alternative approach is to make the upper and lower shells of a golf club head, one at a time, by pressing a metal-based composite material. However, the upper and lower shells thus made tend to have coupling surfaces with deformed edges due to material extension during pressing, or have partially deformed peripheries as a result of improper removal of the pressed parts, so that contact surfaces along the peripheries of the upper and lower shells do not match closely with each other and, in consequence, defective or commercially undesirable products are produced. Since the metal-based composite material is relatively costly, a high defective rate can significantly increase manufacturing costs of the products.

### BRIEF SUMMARY OF THE INVENTION

In view of the aforesaid problems associated with the processing of upper and lower shells of a wood golf club head, the present invention provides an improved method for making a golf club head, wherein upper and lower shells of the golf club head are processed by arranging two unit shells to be pre-processed at the same time in an alternate or non-alternate manner, with a strip of excess material interposed therebetween for constraining an extension force generated while the two unit shells are formed, so that when the excess material is cut off from the two formed unit shells, the upper and lower shells thus made have improved ends of parts and close contact surfaces.

A primary objective of the present invention is to provide steps for processing upper and lower shells of a golf club head. Therein, a metal-based or non-metal-based composite material is provided which has a necessary thickness and whose area and total width are large enough to make at least two unit shells in an alternate or non-alternate arrangement, as determined by widths and surface curvatures of the upper and lower shells of the golf club head to be pre-processed, in which a strip of excess material is reserved at a border between the two unit shells for constraining an extension force generated while the unit shells are formed. Afterward, the two alternately or non-alternately arranged unit shells are integrally formed through a forming process, wherein the extension force generated while the two unit shells are formed is constrained by the excess material at the border between the unit shells. Consequently, when the excess material is cut off from the two formed unit shells, the upper and lower shells thus obtained have close contact surfaces and improved ends of parts.

A second objective of the present invention is to provide the foregoing steps, wherein a width of the strip of excess material at the border between the at least two alternately or non-alternately arranged unit shells is determined by surface curvatures of the unit shells intended as upper and lower shells of a golf club head.

A third objective of the present invention is to provide the foregoing steps, wherein the at least two alternately or non-alternately arranged unit shells formed in each forming process are both intended as the lower shell of the golf club head.

A fourth objective of the present invention is to provide the foregoing steps, wherein the at least two alternately or non-alternately arranged unit shells formed in each forming process are both intended as the upper shell of the golf club head.

A fifth objective of the present invention is to provide the foregoing steps, wherein the at least two alternately or non-alternately arranged unit shells formed in each forming process are intended as a pair of the upper and lower shells of the golf club head.

### BRIEF DESCRIPTION OF THE SEVERAL VIEWS OF THE DRAWINGS

The invention as well as a preferred mode of use, further objectives and advantages thereof will be best understood by referring to the following detailed description of illustrative embodiments in conjunction with the accompanying drawings, wherein:

FIG. 1 is a perspective view showing processing of unit shells intended as a lower shell of a golf club head according to the present invention,

FIG. 2 is a top view showing processing of the unit shells intended as the lower shell of the golf club head according to the present invention;

FIG. 3 is a perspective view showing processing of unit shells intended as an upper shell of the golf club head according to the present invention;

FIG. 4 is a top view showing processing of the unit shells intended as the upper shell of the golf club head according to the present invention;

FIG. 5 is an exploded perspective view of the golf club head according to the present invention;

FIG. 6 is a perspective view of the golf club head according to the present invention;

FIG. 7 is a top view showing processing of unit shells in a different arrangement, intended for the golf club head according to the present invention; and

FIG. 8 is a top view showing processing of unit shells in another different arrangement, intended for the golf club head according to the present invention.

### DETAILED DESCRIPTION OF THE INVENTION

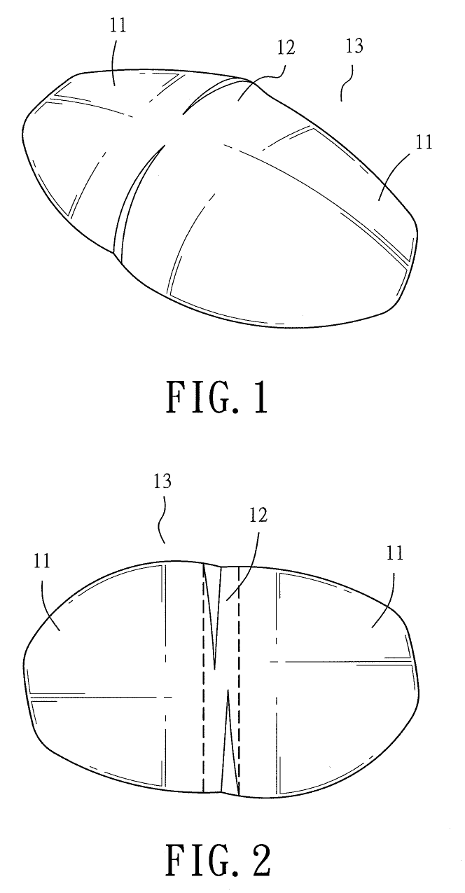

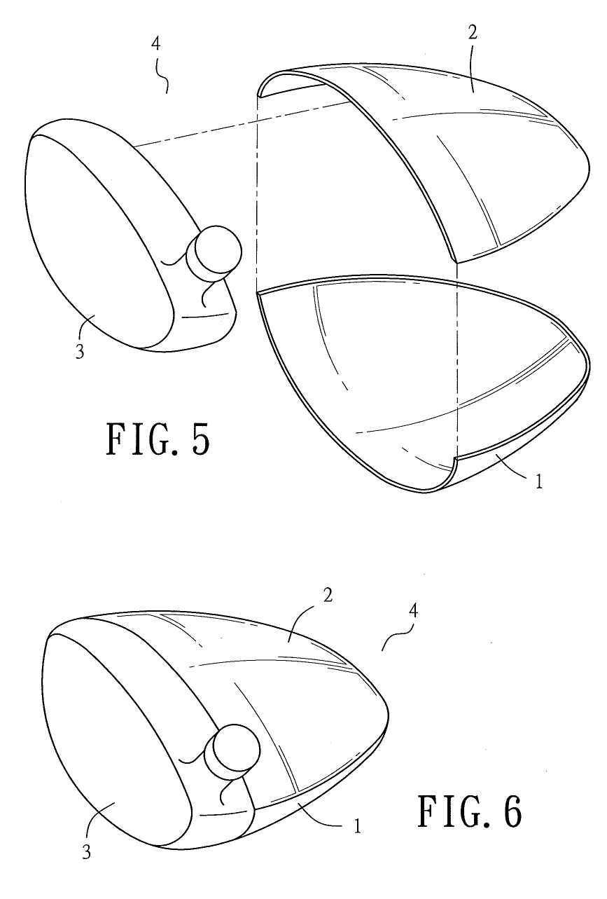

The present invention provides a method for making a golf club head 4 (as shown in FIGS. 5 and 6) comprising a lower shell 1, an upper shell 2 and a striking plate 3. More particularly, the present invention provides steps for processing the upper and lower shells 2 and 1 (as shown in FIGS. 1 through 4) of the golf club head 4. The steps for processing the lower shell 1 are described below with reference to FIGS. 1 and 2.

a. A metal-based or non-metal-based composite material 13 (implemented in this embodiment by a sheet of titanium alloy as an example of metal-based composite material) is provided which has a necessary thickness and whose area and total width are large enough for making at least two unit shells 11 in an alternate or non-alternate arrangement, as determined by a width and a surface curvature of the lower shell 1 of the golf club head 4 to be pre-processed. A strip of excess material 12 is reserved at a border between the two unit shells 11 for constraining an extension force generated while the unit shells 11 are formed.

b. The two alternately or non-alternately arranged unit shells 11 are integrally formed through a forming process. The extension force generated while the two unit shells 11 are formed is constrained by the excess material 12 at the border between the unit shells 11 (as shown in FIG. 2), so as to prevent edges of the unit shells 11 from deforming.

c. The excess material 12 is cut off from the two formed unit shells 11 to produce two lower shells 1 (as shown in FIG. 5) having contact surfaces capable of making close contact with matching shells.

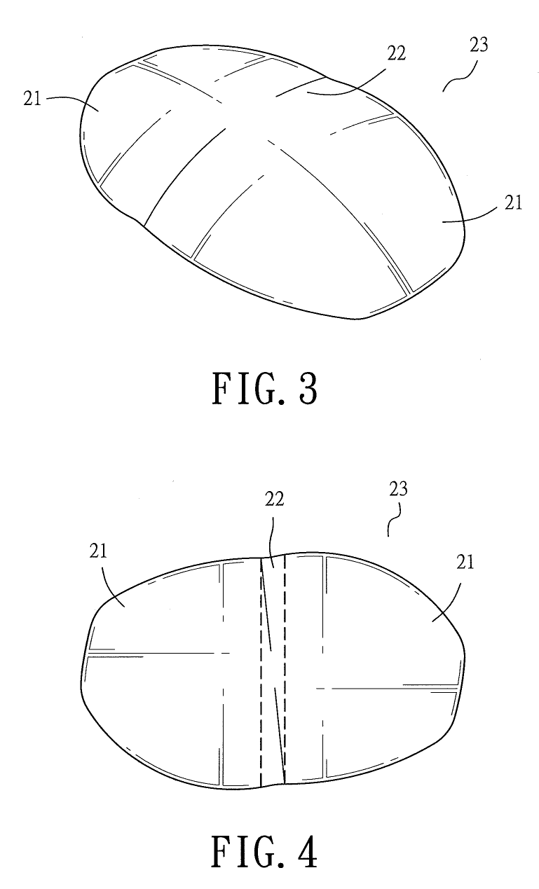

The steps for processing the upper shell 2 (as shown in FIGS. 3 and 4) are the same as those for the lower shell 1, except that an area of a metal-based or non-metal-based composite material 23 necessary for accommodating two unit shells 21 in an alternate or non-alternate arrangement is determined by a width and a surface curvature of the upper shell 2, and that a width of a strip of excess material 22 reserved at a border between the two unit shells 21 depends on surface curvatures of the unit shells 21 intended as the upper shell 2 of the golf club head 4, wherein the excess material 22 serves to constrain an extension force generated while the two unit shells 21 intended as the upper shell 2 are formed. (If the unit shells 21 intended as the upper shell 2 have larger surface curvatures, the strip of excess material 22 will be narrower. If the unit shells 11 intended as the lower shell 1 as shown in FIG. 2 have smaller surface curvatures, the strip of excess material 12 will be wider.) After the excess material 22 is cut off from the two unit shells 21, two upper shells 2 having contact surfaces capable of making close contact with matching shells are obtained, as shown in FIG. 5.

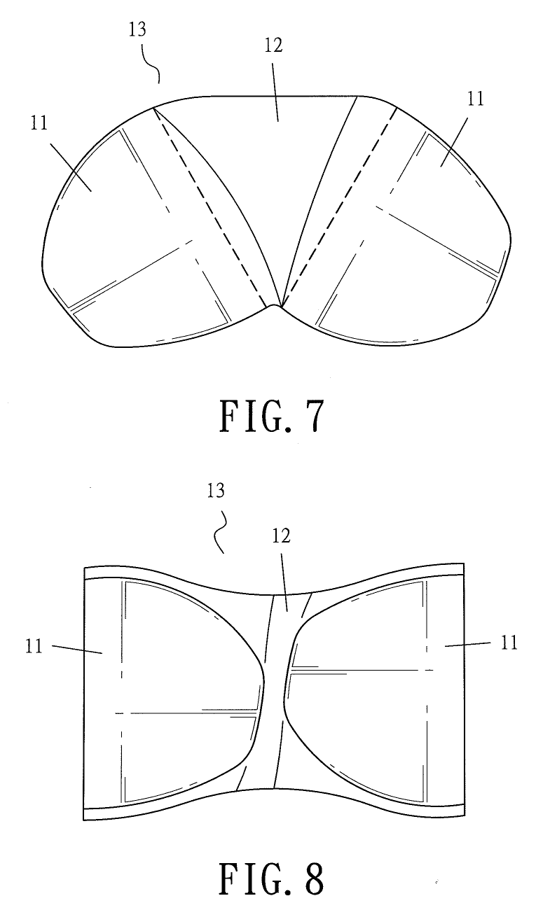

In addition to the alternate or non-alternate arrangement, the two unit shells 11 formed in each forming process may also be arranged in such a way that adjacent edges of the unit shells 11 form an included angle (as shown in FIG. 7), or the two unit shells 11 may be arranged alternately and in a reverse direction (as shown in FIG. 8), so as to form upper and lower shells having the desired widths and surface curvatures.

Moreover, the at least two alternately or non-alternately arranged unit shells formed in each forming process can both be the unit shells 11 intended as the lower shell 1 of the golf club head 4 (as shown in FIGS. 1 and 2), or both be the unit shells 21 intended as the upper shell 2 of the golf club head 4 (as shown in FIGS. 3 and 4), or be a pair of the unit shells 21 and 11 intended respectively as the upper and lower shells 2 and 1 of the golf club head 4.

It should be noted that, in addition to titanium alloy, the metal-based composite material used in the present invention may also include stainless steel, carbon steel, alloy steel, aluminum alloy, alloy-selenium alloy, aluminum-scandium alloy, aluminum-magnesium alloy, copper alloy, zirconium alloy and tungsten alloy.

Apart from the metal-based composite material, the present invention may also use non-metal-based composite materials such as industrial plastics and carbon fiber composite materials.

The disclosed steps for processing the upper and lower shells of the golf club head are advantageous in that:

1. The upper and lower shells of the golf club head are processed by arranging two unit shells to be pre-processed at the same time in an alternate or non-alternate manner, with the strip of excess material interposed therebetween for constraining the extension force generated while the two unit shells are formed.

2. When the excess material is cut off from the two formed unit shells, the upper and lower shells thus made have close contact surfaces and improved ends of parts, thereby effectively lowering a rejection rate in the course of processing.

1. A method for making a golf club head, comprising steps for processing upper and lower shells of the golf club head, the steps including:
a. providing a metal-based or non-metal-based composite material which has a necessary thickness and whose area and total width are large enough to make at least two unit shells in an alternate or non-alternate arrangement, as determined by widths and surface curvatures of the upper and lower shells of the golf club head to be pre-processed, in which a strip of excess material is reserved at a border between the two unit shells for constraining an extension force generated while the unit shells are formed;.
b. integrally forming the two alternately or non-alternately arranged unit shells through a forming process, wherein the extension force generated while the two unit shells are formed is constrained by the excess material at the border between the unit shells; and
c. cutting off the excess material from the two formed unit shells to produce the upper and lower shells of the golf club head, wherein the upper and lower shells have smooth ends of parts and close contact surfaces.

2. The method for making a golf club head as claimed in claim 1, wherein the strip of excess material at the border between the at least two alternately or non-alternately arranged unit shells has a width determined by surface curvatures of the unit shells intended as the upper and lower shells of the golf club head.

3. The method for making a golf club head as claimed in claim 1, wherein the at least two alternately or non-alternately arranged unit shells formed in each forming process are both intended as the lower shell of the golf club head.

4. The method for making a golf club head as claimed in claim 1, wherein the at least two alternately or non-alternately arranged unit shells formed in each forming process are both intended as the upper shell of the golf club head.

5. The method for making a golf club head as claimed in claim 1, wherein the at least two alternately or non-alternately arranged unit shells formed in each forming process are intended as a pair of the upper and lower shells of the golf club head.

6. The method for making a golf club head as claimed in claim 1, wherein the metal-based composite material is selected from the group consisting of stainless steel, carbon steel, alloy steel, titanium alloy, aluminum alloy, alloy-selenium alloy, aluminum-scandium alloy, aluminum-magnesium alloy, copper alloy, zirconium alloy and tungsten alloy.

7. The method for making a golf club head as claimed in claim 1, wherein the non-metal-based composite material is selected from the group consisting of industrial plastics and carbon fiber composite materials.
